(19) United States
(12) Patent Application Publication
(10) Pub. No.: US 2003/0028827 A1
(43) Pub. Date: Feb. 6, 2003

(54) Method and apparatus for monitoring a computing device

(76) Inventor: Peter Daniel Gray, Toronto (CA)

Correspondence Address: H. Samuel Frost, Bereskin & Parr, Box 401, 40 King Street West, Toronto, ON, M5H 3Y2, CA

(21) Appl. No.: 09/922,276

(22) Filed: Aug. 6, 2001

(51) Int. Cl. G06F 11/22

(52) U.S. Cl. 714/46; 714/48

(57) ABSTRACT

A method and apparatus for monitoring a computing device and detecting whether an error condition is present in the computing device. In one aspect, the present invention relates to an apparatus that can be coupled to a controlled computing device, comprising an input stage for receiving signals from the controlled computing device, and a control stage for determining whether an error condition is present in the controlled computing device from the signals and generating an error indicator if it is determined that the error condition is present in the controlled computing device. The present invention facilitates the monitoring of the computing device for error conditions automatically, without the need for ongoing direct maintenance of the computing device by a user. In another aspect, the present invention relates to an apparatus for remotely controlling the computing device.

### FIELD OF THE INVENTION

The present invention relates to a method and apparatus for monitoring a computing device, and in some aspects, is more particularly concerned with a method and apparatus for detecting specified conditions in a computing device.

### BACKGROUND OF THE INVENTION

Many organizations employ the use of a system of one or more computing devices (e.g. servers) to provide its members (e.g. employees) with the necessary resources to perform various computing tasks. In some instances, a user or administrator of the system may wish to monitor and perform maintenance on the system from a remote location.

Several systems, methods and apparatus for monitoring and controlling computing devices remotely have been disclosed in the prior art. For example, PCT International Application No. PCT/US95/00180 (International Publication Number WO 95/22137) for METHODS AND APPARATUS FOR REMOTE MONITORING AND CONTROL OF AUTOMATED VIDEO DATA SYSTEMS, U.S. Pat. No. 5,732,212 for a SYSTEM AND METHOD FOR REMOTE MONITORING AND OPERATION OF PERSONAL COMPUTERS, and PCT International Application No. PCT/US99/21891 (International Publication Number WO 00/17766) for a SYSTEM AND METHOD FOR ACCESSING AND OPERATING PERSONAL COMPUTERS REMOTELY relate to the remote monitoring of computing devices.

### SUMMARY OF THE INVENTION

The present invention relates to a method and apparatus for monitoring a computing device.

In one aspect, the present invention relates to an apparatus for remotely monitoring and controlling a computing device comprising one or more stages adapted to: receive one or more first signals from a controlled computing device, receive one or more second signals from a user over a network connection, transmit at least one of the one or more first signals to the user over the network connection, and transmit the one or more second signals to the controlled computing device; where the apparatus is coupled to a relay, where the relay is coupled to both the controlled computing device and a power source for the controlled computing device, where the relay is moveable between a first position and a second position, where in the first position, the relay causes the power source to be coupled to the controlled computing device, where in the second position, the relay causes the power source to be decoupled from the controlled computing device, and where the one or more stages are adapted to control the movement of the relay between the first and second positions.

In another aspect, the present invention relates to an apparatus for remotely monitoring and controlling a computing device, wherein the apparatus comprises a plurality of multiplexers that permit each of a plurality of users to select a controlled computing device to be monitored from a plurality of computing devices.

In another aspect, the present invention relates to an apparatus for monitoring a computing device comprising one or more stages adapted to: receive one or more signals from a controlled computing device; determine from the one or more signals whether an error condition is present in the controlled computing device; and generate an error indicator upon determining that an error condition is present in the controlled computing device.

In another aspect, the present invention relates to a method of monitoring a computing device comprising the steps of receiving signals generated by a controlled computing device, determining from the signals whether an error condition is present in the controlled computing device, and generating an error indicator upon determining that the error condition is present in the controlled computing device.

In another aspect, the present invention relates to a method and apparatus for monitoring a computing device, where a relay is coupled to both a controlled computing device and a power source for the controlled computing device, and where upon determining that an error condition is present in the controlled computing device, the relay is moved to a second position such that the controlled computing device is powered off, and then to the first position such that the controlled computing device is powered on.

In another aspect, the present invention relates to a method and apparatus for monitoring a computing device, where an error indicator is used to generate a message that comprises data for a log record to be stored in a storage device.

In another aspect, the present invention relates to a method and apparatus for monitoring a computing device, where an error indicator is used to generate a message to be sent to a user through a network.

In another aspect, the present invention relates to a method and apparatus for monitoring a computing device, where it is determined whether a controlled computing device is operating in a text mode, and generates an error indicator if the controlled computing device is operating in a text mode.

In another aspect, the present invention relates to a method and apparatus for monitoring a computing device, where it is determined whether an output data signal comprises a prespecified string of characters or whether an output data signal has not comprised a prespecified string of characters within a prespecified interval, and where an error indicator is generated if the output data signal comprises a prespecified string of characters or if the output data signal has not comprised a prespecified string of characters within a prespecified interval respectively.

In another aspect, the present invention relates to a method and apparatus for monitoring a computing device, where one or more test signals are generated that simulate a press of a prespecified key on a keyboard, where it is determined whether a signal has not been received from a computing device to illuminate a prespecified light on the keyboard in response to the test signals, and where an error indicator is generated if the signal has not been received from the computing device to illuminate the prespecified light on the keyboard in response to the test signals.

In another aspect, the present invention relates to a method and apparatus for monitoring a computing device, where one or more ping requests are generated, where it is determined whether an echo response has not been received in response to a prespecified percentage of the one or more ping requests from a controlled computing device within a prespecified period of time, and where an error indicator is generated if an echo response has not been received in response to a prespecified percentage of the one or more ping requests from a controlled computing device within a prespecified period of time.

In another aspect, the present invention relates to a method and apparatus for monitoring a computing device, where a request to retrieve a web page from a controlled computing device is generated, where it is determined whether the web page was not successfully retrieved from the controlled computing device in response to the request, and where an error indicator is generated if the web page was not successfully retrieved from the controlled computing device in response to the request.

In another aspect, the present invention relates to a method and apparatus for monitoring a computing device in which a user may define a plurality of error conditions to be monitored.

The present invention is directed to an apparatus and method for monitoring a computing device, and in particular, according to some aspects of the present invention, to detect whether one or more error conditions are present in the computing device. These error conditions typically arise when the computing device is not functioning properly or in some specific manner. These error conditions are detected by monitoring the electrical outputs of the controlled computer.

Advantageously, the present invention facilitates the monitoring of the computing device for error conditions automatically, without the need for ongoing direct maintenance of the computing device or monitoring device by a user.

Furthermore, the simplicity of the present invention, relative to some prior art devices that relate generally to the remote monitoring of a computing device, may allow an apparatus configured in accordance with the present invention to be constructed more compactly and less expensively than those prior art devices.

### BRIEF DESCRIPTION OF THE DRAWINGS

For a better understanding of the present invention, and to show more clearly how it may be carried into effect, reference will now be made, by way of example, to the accompanying drawings used to describe preferred embodiments of the present invention, and in which:

FIG. 1 is a schematic diagram of an embodiment of the present invention;

FIG. 2 is a schematic diagram that illustrates components of a monitoring device according to an embodiment of the present invention;

FIGS. 3A and 3B are schematic diagrams that illustrate components of a monitoring device in variant embodiments of the present invention; and

FIG. 4 is a flowchart illustrating the steps of a method of monitoring a computing device in accordance with an embodiment of the present invention.

Similar references are used in different figures to denote similar components.

### DETAILED DESCRIPTION OF THE PREFERRED EMBODIMENTS

The present invention relates generally to an apparatus and method for monitoring a computing device.

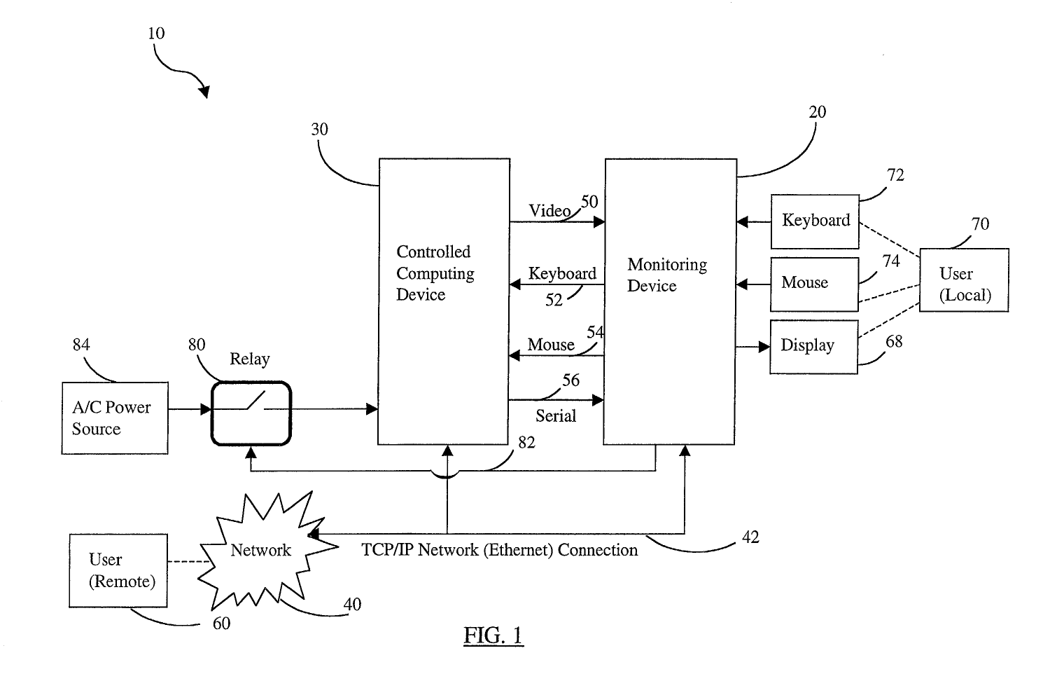

Referring to FIG. 1, a schematic diagram of an embodiment of the present invention in which components of a system shown generally as 10 for monitoring a computing device is provided. Importantly, system 10 comprises a monitoring device 20 designed in accordance with the present invention.

In a preferred embodiment of the invention, monitoring device 20 is a device that can be connected between a controlled computing device 30 and a network 40. Advantageously, monitoring device 20 is not a personal computer (PC), but is a piece of external hardware that operates independently of controlled computing device 30 and that remains functional even if controlled computing device 30 has crashed or failed in any way. Monitoring device 20 will, in some instances, be less complex and less expensive to manufacture than a PC designed to perform the same functions as monitoring device 20.

Typically, controlled computing device 30 is a server PC which has been selected for monitoring by a user. However, controlled computing device 30 may also be one of a variety of other different computing devices for performing a variety of different functions, such as a web server, a client PC, a legacy computer system that does not otherwise attach to a network (such as older DOS computers), a piece of large industrial equipment that by includes a PC-based control interface (such as a CNC milling machine, or SMT parts placement machine), or a deployed system where modifications to internal hardware or software are not permitted for risk management or security reasons (e.g. military systems, ground-based avionics systems), for example. Network 40 is typically a TCP/IP network such as the Internet, but may also be some other network (e.g. an Intranet). Monitoring device 20 is connected to network 40 by a network connection 42. Controlled computing device 30 may also be connected to network 40 by network connection 42 or some other network connection.

Monitoring device 20 is connected to controlled computing device 30 by several connections, including for example, a video signal connection 50 for carrying video output from monitoring device 20. Monitoring device 20 may also be connected to controlled computing device 30 by other output data signal connections for carrying output from controlled computing device 30, including for example, serial data signal connection 56 for carrying output from a serial port on controlled computing device 30. Monitoring device 20 may also be connected to controlled computing device 30 by signal connections for input devices, including for example, a keyboard signal connection 52 for carrying keyboard input and a mouse signal connection 54 for carrying mouse input.

The connections between monitoring device 20 and controlled computing device 30, and the signals carried on those connections, may differ in variant configurations of system 10, depending on what specific outputs of the controlled computing device 30 are to be monitored and what specific input devices, if any, are to provide input to the controlled computing device 30.

Monitoring device 20 may be used to allow a remote user 60 to remotely monitor and control controlled computing device 30 (e.g., as if the user was operating a terminal located in the immediate vicinity of controlled computing device 30). Monitoring device 20 allows remote user 60 to perform maintenance tasks that remote user 60 might otherwise perform locally on controlled computing device 30. For example, remote user 60 may be a system administrator who wishes to maintain the computing controlled device 30 remotely from a network 40, such as the Internet. Although remote user 60 is referred to as “remote”, the actual distance between the location of the remote user 60 and controlled computing device 30 will depend on the size and layout of network 40, and the exact location of the remote user 60 on the network. For example, even if the network 40 is an internal network of an organization, remote user 60 may be in the same room as controlled computing device 30 and still be referred to as a “remote” user.

The ability to remotely monitor and control controlled computing device 30 is facilitated by monitoring device 20, which digitizes video output carried by video signal connection 50 (e.g. VGA graphics) from controlled computing device 30, and sends the digitized output to remote user 60 on network 40 over network connection 42. Input signals from input devices (e.g. keyboard input and/or mouse input) can be simulated by monitoring device 20 as directed by remote user 60 for transmission to controlled computing device 30.

Monitoring device 20 may also be configured to transmit signals it receives (e.g. over video signal connection 50 and serial data signal connection 56) to a local output device, such as a display 68 (e.g. a VGA screen) operated by a local user 70, or other device such as a text display device or an output peripheral device. Monitoring device 20 may also be configured to receive signals from local input devices operated by local user 70 such as a local keyboard 72 and a local mouse 74 accessible by local user 70, and to transmit those signals to controlled computing device 30 (e.g. over keyboard signal connection 52 and mouse signal connection 54 respectively).

Monitoring device 20 can employ software to multiplex input from the local user 70 and the remote user 60. This means that a user (e.g. local user 70 and/or remote user 60 as configured by the software) can configure the software to “share” or mix the inputs from both local user 70 and remote user 60 for transmission to controlled computing device 30, or the software can enforce a mutual exclusion mechanism, where only one of local user 70 and remote user 60 can be in control of a controlled computing device 30 at any given time. Alternatively, monitoring device 20 may include hardware means (e.g. an input switch) that controls whether input is to be received from remote user 60 or local user 70, and hardware means (e.g. an output switch) that controls the flow of data received by controlled computing device 30 to a remote user 60 or local user 70.

Preferably, monitoring device 20 is connected to a relay 80. Relay 80 may be internal to monitoring device 20 or external to monitoring device 20. Monitoring device 20 may be connected to relay 80 by a relay connection 82. Relay 80 controls the power source 84 for controlled computing device 30. In one embodiment of the invention, relay 80 is connected between power source 84 (e.g. an A/C outlet) and controlled computing device 30, to control the flow of electricity required to operate controlled computing device 30 from power source 84 to controlled computing device 30.

Relay 80 is preferably a switch that is moveable between a first position and a second position. The first position is referred to as an “on” position, in which relay 80 causes power source 84 to be connected to controlled computing device 30 (i.e. the switch is closed), and in which electricity from power source 84 can flow to controlled computing device 30 so as to power on controlled computing device 30. The second position is referred to as an “off” position, in which relay 80 causes power source 84 to be disconnected from controlled computing device 30 (i.e. the switch is open), and in which electricity from power source 84 is prevented from flowing to controlled computing device 30, thus powering off controlled computing device 30. The movement of relay 80 is controlled by monitoring device 20. Instructions to control the movement of relay 80 may be provided to monitoring device 20 by remote user 60, facilitating the powering on and powering off of controlled computing device 30 remotely. Controlled computing device 30 can be reset (i.e. rebooted) by first powering off controlled computing device 30 and then powering it on, in the event that its software has crashed, for example. Alternatively, remote user 60 may simply instruct to power on the controlled computing device 30 if it is off, or to power off the controlled computing device if it is on.

Relay 80 is also preferably of “normally-closed” type, so that a failure of monitoring device 20 will not cause power to controlled computing device 30 to be lost.

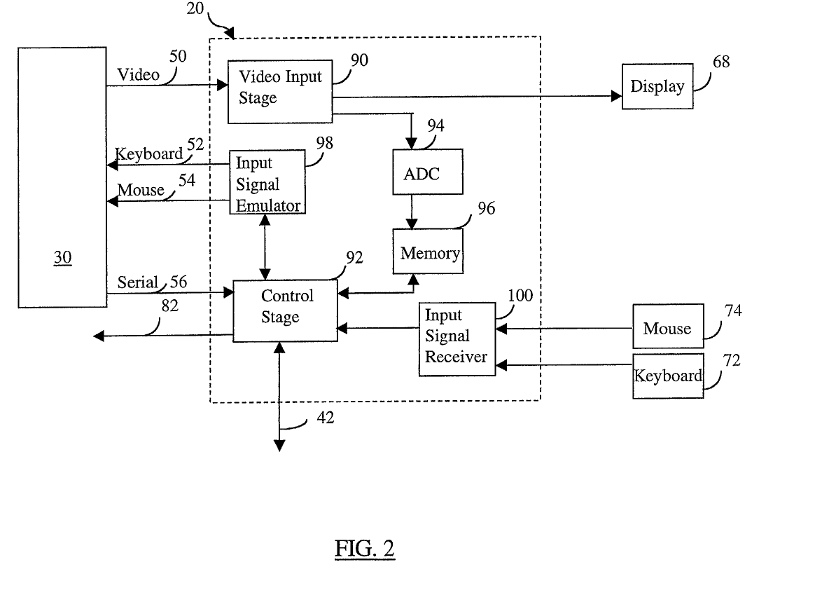

Referring now to FIG. 2, a schematic diagram that illustrates components of a monitoring device according to an embodiment of the present invention is provided.

In this embodiment, monitoring device 20 consists of two stages: a video input stage 90 and a control stage 92. Video input stage 90 and control stage 92 can each be implemented using separate sets of one or more semiconductor devices, circuits, or microprocessors. For example, video input stage 90 may be implemented using a gate array (e.g. an FPGA) while control stage 92 may be implemented using a gate array and a microprocessor chip. Alternatively, the functions of video input stage 90 and control stage 92 could also be distributed across multiple semiconductor devices, circuits, or microprocessors in variant configurations of components of monitoring device 20, or implemented using a single semiconductor device, circuit, or microprocessor. Monitoring device 20 may comprise more or less stages in variant embodiments of the invention.

Video input stage 90 is designed to receive signals from controlled computing device 30, such as video signals over video signal connection 50. Output data signals over a serial data signal connection 56, for example, are received by control stage 92, although in variant embodiments, a different stage may receive output signals from controlled computing device 30 for subsequent transmission to control stage 92. Signals received from controlled computing device 30 by video input stage 90 can be transmitted to a local user (e.g. 70 of FIG. 1) using display 68, and/or communicated to control stage 92 for transmission to a remote user (e.g. 60 of FIG. 1) over network connection 42.

If desired, analog signals received from controlled computing device 30 such as video signals can be digitized using an analog-to-digital converter (ADC) 94 before transmission to a user (e.g. a remote user 60). For instance, three analog signals (e.g. red, green, and blue) can be simultaneously digitized and converted into digits. In FIG. 2, ADC 94 is positioned to receive analog signals from video input stage 90 before communicating digitized signals to control stage 92. However, in variant configurations of monitoring device 20, ADC 94 may be connected to different components and may digitize signals earlier or later in the process of transmitting analog signals received from controlled computing device 30 to a user in digitized form. Furthermore, digitized output of ADC 94 may be stored in a memory 96 for subsequent retrieval by control stage 92.

ADC 94 can be embodied in its own device, or contained within other devices (e.g. as part of video input stage 90 or control stage 92). These devices may also performing timing recovery functions, as is needed to accurately sample high-speed (e.g. 250 MHz bandwidth) video signals. A single ADC 94 may be used to digitize signals from one controlled computing device 30 or multiple controlled computing devices 30 at a time. Alternatively, a dedicated ADC 94 could be assigned to each of multiple controlled computing devices 30. However, it may be more cost-effective to have shared resources such as ADCs 94, for all computing devices. Other configurations of ADCs 94 may also be used.

Control stage 92 controls the simulation or emulation of input data to be transmitted to controlled computing device 30. The simulation or emulation of input data can be performed by an input signal emulator 98, which can be a separate device such as a microprocessor, and which communicates with control stage 92. The input data that is simulated or emulated can be generated automatically by control stage 92, or at the direction of remote user 60 or local user 70 as described in further detail below. While the functions of input signal emulator 98 may be integrated into another device in variant configurations of monitoring device 20, the use of a separate device may, advantageously, permit the simulation or emulation functions to continue even if power to monitoring device 20 is removed. This can be facilitated by powering the input signal emulator 98 from the power source of the controlled computing device 30 (e.g. via the same pins which exist in local keyboard 72 and local mouse 74).

Control stage 92 may also be designed to receive signals from local input devices such as a local keyboard 72 or local mouse 74, for example. Signals from local input devices can be received by an input signal receiver 100 that communicates with control stage 92. The signals can then be transmitted to controlled computing device 30 using input signal emulator 98, over keyboard signal connection 52 and mouse signal connection 54, for example. However, in some uses of the present invention, where only remote access to controlled computing device 30 is required for example, video input stage 90 need not be configured to receive signals from local input devices. In the configuration of FIG. 2, input signal receiver 100 exists as a separate device; however, the functions of input signal receiver 100 may be integrated with other devices (e.g. those which implement control stage 92) in variant configurations of monitoring device 20.

Control stage 92 is designed not only to transmit signals received from controlled computing device 30 to remote user 60, but also to transmit signals relating to input data (e.g. keyboard input and mouse input) from remote user 60 to controlled computing device 30. The input data that is to be transmitted to controlled computing device 30 may be received by remote user 60 over network connection 42. In this case, input data received from remote user 60 can be transmitted to controlled computing device 30, through input signal emulator 98, allowing remote user 60 to remotely monitor and control controlled computing device 30.

Control stage 92 can also control the movement of a relay (e.g. 80 of FIG. 1) using relay connection 82, in order to power on and power off controlled computing device 30. For example, if software running on controlled computing device 30 has crashed or controlled computing device 30 is otherwise not working properly, and it is desired that controlled computing device 30 be turned off and restarted (i.e. rebooted), controlled computing device 30 can first power off the controlled computing device 30 if controlled computing device 30 is not already powered off, possibly for a predetermined amount of time (e.g. several seconds for a simple reboot, several minutes if the controlled computing device 30 is to be cooled, or some other duration depending on the reason for rebooting), and subsequently power on controlled computing device 30. Relay 80 may be controlled in response to a request from remote user 60, or by control stage 92 without direction from remote user 60.

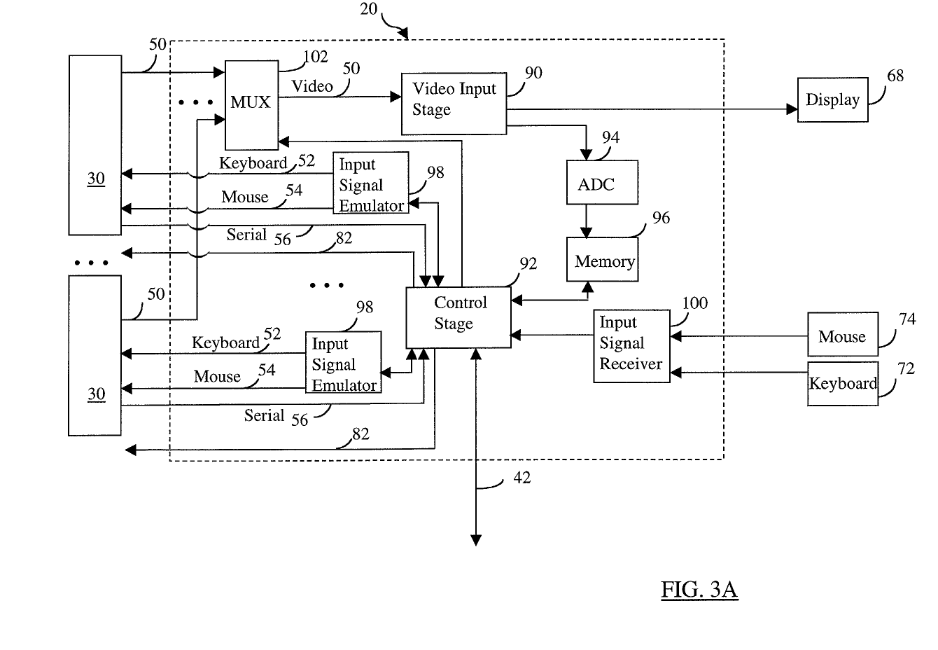

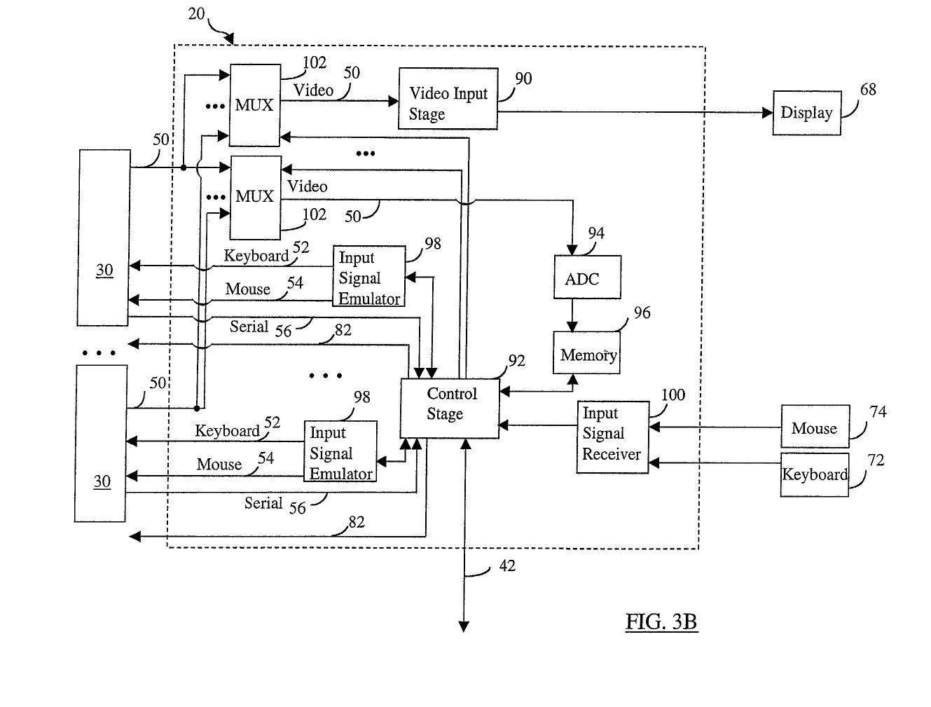

Referring to FIG. 3A, a schematic diagram that illustrates components of a monitoring device in a variant embodiment of the present invention is provided. In this embodiment, monitoring device 20 comprises one or more multiplexers 102 (in the form of one or more semiconductor devices or one or more circuits, for example) to allow multiple controlled computing devices 30 to be controlled and monitored. Multiplexers 102 can be controlled by control stage 92, which can select a specific controlled computing device 30 to be monitored and/or controlled by remote user 60 or local user 70. Preferably, when multiple controlled computing devices 30 are connected to monitoring device 20, separate input signal emulators 98 are used to transmit signals from input devices such as a keyboard and mouse to each of the controlled computing devices 30. This allows emulated input to be generated for each controlled computing device 30 at all times, even if it is not the selected specific controlled computing device 30 being directly monitored and/or controlled by remote user 60 and local user 70. For example, even though remote user 60 and local user 70 may be viewing the video output of the selected specific controlled computing device 30 and controlling the selected specific controlled computing device 30 (either by remote user 60, local user 70, or both depending on how monitoring device 20 is configured), emulated input may still be provided to all other controlled computing devices 30 to allow automatic monitoring (e.g. in the “background”) by control stage 92.

Referring to FIG. 3B, a schematic diagram that illustrates components of a monitoring device in another variant embodiment of the present invention is provided. In this embodiment, monitoring device 20 comprises two sets of one or more multiplexers 102 (each set in the form of one or more semiconductor devices or one or more circuits, for example). A first set of multiplexers 102 can be used to allow a first specific controlled computing device 30 to be selected for monitoring and controlling by a first user (e.g. remote user 60 of FIG. 1), while a second set of multiplexers 102 can be used to allow a second specific controlled computing device 30 to be selected for monitoring and controlling by a second user (e.g. local user 70 of FIG. 1). The first specific controlled computing device 30 to be selected for monitoring and controlling by the first user may or may not be different from the second specific controlled computing device 30 selected for monitoring and controlling by the second user. Again, preferably, separate input signal emulators 98 are used to transmit signals from input devices such as a keyboard and mouse to each of the controlled computing devices 30. Emulated input may be generated for each controlled computing device 30 at all times, even if a given controlled computing device 30 is not being directly controlled or monitored by either the first or second users.

In other variant embodiments of the invention, multiple local and/or remote users may monitor and control a controlled computing device 30. For example, a group of ten local and/or remote users may all be viewing the same output from a selected controlled computing device 30, and each user of the group may provide input to the selected controlled computing device 30. Multiple sets of multiplexers 102 may be used to allow multiple local and/or remote users to monitor and control the selected controlled computing device 30. Multiple sets of multiplexers 102 may also be used to allow each of multiple local and/or remote users to monitor and control different controlled computing devices 30 of a group of multiple computing devices. In some variant embodiments, multiple video input stages 90 and control stages 92 may be implemented to permit access to multiple computing devices by multiple users.

Referring back to FIG. 2, which illustrates components of monitoring device 20 in an embodiment of the present invention, monitoring device 20 may also be configured to facilitate the monitoring of controlled computing device 30 for error conditions. Error conditions are conditions which, if present in the controlled computing device 30, usually indicate that controlled computing device 30 is not functioning properly, or that controlled computing device 30 is functioning in some other specified (usually undesired) manner. These error conditions are detected by monitoring device 20 by monitoring the electrical outputs of the controlled computing device 30, typically at some regular interval.

A monitoring device 20 configured to facilitate the monitoring of controlled computing device 30 for error conditions may also be configured to permit remote control of controlled computing device 30 by a remote user as described earlier in this specification with reference to FIG. 2. However, it will be apparent to those skilled in the art that a monitoring device 20 configured to facilitate the monitoring of controlled computing device 30 for error conditions in accordance with the present invention may exist as a separate device, and need not provide for remote control capabilities (other than what may be necessary to monitor error conditions).

A monitoring device 20 configured to facilitate the monitoring of controlled computing device 30 for error conditions may exist in a system that contains fewer components than system 10 of FIG. 1, since some of the components of system 10 (e.g. local display 68, local mouse 74) may not be required to monitor error conditions in the controlled computing device 30.

The monitoring of controlled computing device 30 for error conditions can be performed automatically by monitoring device 20 without the need for intervention by a user or the need for ongoing direct maintenance of controlled computing device 30 or monitoring device 20 by a user.

In a preferred embodiment of the invention, video input stage 90 is adapted to receive one or more video signals to be transmitted to control stage 92 (via other devices such as ADC 94 and a memory 96). Other signals such as an output data signal over serial data signal connection 56 may also be transmitted to and received by control stage 92. These signals received from controlled computing device 30 can be used by control stage 92 to monitor controlled computing device 30.

Signals received from controlled computing device 30 may have been generated by controlled computing device 30 in response to test signals transmitted to controlled computing device 30 by control stage 92 prior to the reception of the signals by components of monitoring device 20.

Signals received from controlled computing device 30 by control stage 92 are used to determine whether an error condition is present in controlled computing device 30. Typically, only a subset of all signals received from controlled computing device 30 are necessary to determine whether any particular error condition is present in controlled computing device 30. If it is determined than an error condition is present in controlled computing device 30, control stage 92 generates an error indicator (e.g. a signal that identifies a specific detected error condition) to indicate that the error condition is present in controlled computing device 30. The error indicator may then be output to a remote user 60 or to a local user 70 (e.g. using a set of LEDs). Alternatively, the error indicator (or some form thereof) may be stored in a memory or storage device.

Control stage 92 comprises software [not separately shown] can be configured to permit the monitoring device 20 to determine (i.e. detect) what specific conditions that may be present in a controlled computing device 30 are to be treated as error conditions. A default set of error conditions to be monitored can be defined. Alternatively, a user (remote user 60 or local user 70) may be given the facility to select specific error conditions to be monitored by the monitoring device 20.

The software can also generate a message from a generated error indicator. The message may comprise data for a log record that can be stored in a storage device such as a memory 102 internal to monitoring device 20 or some other storage device internal or external to monitoring device 20, for later retrieval (e.g. by a remote user 60 of FIG. 1). The data may include, for example, a record of the time and date the error condition was determined (i.e. detected), data items from data received from controlled computing device 30, and/or other information as desired.

The message may also be one that is sent to a remote user 60 on a network (e.g. 40 of FIG. 1) through network connection 42. In this case, the message may be an electronic mail message, or a message for transmission to a pager, cell phone, other portable communications device, or any other device connected to the network. Since many of these devices can receive messages, a user may be alerted to a potential problem with controlled computing device 30 almost instantaneously. The message may also be generated by module 100 in a variety of formats as is known.

Optionally, when control stage 92 determines that an error condition is present in controlled computing device 30, control stage 92 may cause relay 80 that controls power to controlled computing device 30 to move to the “off” position (possibly for a pre-determined period of time) to power off the controlled computing device 30, and subsequently to move relay 80 to the “on” position in order to power on the controlled computing device 30, in order to effect a reboot of controlled computing device 30. This assumes that the controlled computing device 30 is able to start running on its own after the reboot.

Some examples of error conditions that may become present in a controlled computing device 30 during its operation, and which may be monitored and detected by monitoring device 20 are described below.

Text mode detection: Many computing devices output high resolution graphics signals when they are operating normally (e.g. when Microsoft Windows is active). However, during the reboot phase of a computing device's operation, the computing device operates in a special video mode called “text mode”. This text mode has special electrical properties which can be detected from the output of controlled computing device 30. For example, “text mode” can be defined as any video mode with 720 pixels of resolution horizontally, and/or a horizontal signal of less than 40 kHz. However, other definitions of “text mode” as known in the art may be employed. Thus, monitoring device 20 can be configured to detect the “text mode” as an error condition, a condition that usually indicates that the computing device has reset itself (of its own accord) or has crashed with an error message on the screen (sometimes called the “blue screen of death”).

String detection: An output data port such as a serial port (e.g. RS-232) of controlled computing device 30 can be monitored for a prespecified string of characters. Monitoring device 20 can be configured to either expect the prespecified string within a prespecified period (e.g. once every 5 minutes), or alternatively, to not expect the prespecified string. If either case fails to occur, as configured, the monitoring device 20 considers it as an error condition. The monitoring of this error condition can be useful if serial error messages are output over a serial port. A message generated from an error indicator may include these serial error messages as part of the message. Other output data signals from controlled computing device 30 can be monitored for the presence (or lack thereof) of a prespecified string of characters.

Keyboard light detection: Monitoring device 20 can be configured to continuously simulate the pressing of a “Num Lock” keyboard key (or some other key such as “Caps Lock” or “Scroll Lock” , for example) as input to a controlled computing device 30. If controlled computing device 30 is operating properly, it will transmit a signal to illuminate the corresponding “Num Lock” light (or other light if a different key was used) on local keyboard 72 in response. Monitoring device 20 is configured to detect if this fails to occur, and considers the failure an error condition. Typically, this failure indicates a serious software failure or lock-up on controlled computing device 30.

Echo detection: Many computers can be connected to a network (e.g. 40 of FIG. 1) such as an internal local area network (LAN) or the Internet. They often perform some function over that network. A failure of controlled computing device 30 to respond to network inquiries typically indicates a failure. Monitoring device 20 can be configured to generate “ping” requests for transmission to controlled computing device 30. The ping requests should elicit an “echo” response whenever they are received by controlled computing device 30. Monitoring device 20 can be configured to monitor controlled computing device 30 for responses to generated ping requests. If more than a prespecified percentage (e.g. 50%) of such ping requests do not elicit an echo response within a prespecified period of time, then an error condition is detected. This error may be the result of a network failure or a software crash on the controlled computing device 30, for example.

Monitoring device 20 can also be configured to generate requests to retrieve a web page from controlled computing device 30, if controlled computing device 30 is a web server. Monitoring device 20 simulates a request to retrieve a web page, and if the web page fails to be retrieved successfully from controlled computing device 30 in response to the request, an error condition is detected. A successful retrieval of a web page may be deemed any retrieval of a non-zero number of bytes within a reasonable, possibly prespecified, time-limit. However, other criteria may be used to determine what constitutes a successful retrieval of a web page.

Monitoring device 20 may also be configured to detect other error conditions, including non-responsiveness to simulated mouse movements by monitoring video signals from a controlled computing device 30, and loss of power to controlled computing device 30, for example.

Monitoring device 20 may be configured to monitor controlled computing device 30 for one, some, or all of the above error conditions, and/or other error conditions if desired.

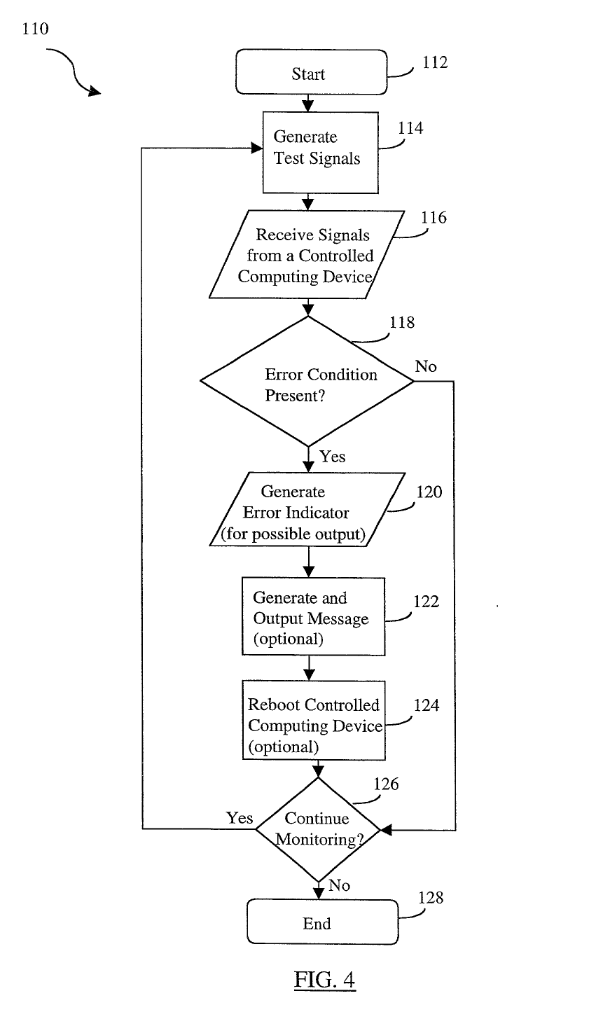

FIG. 4 is a flowchart illustrating the steps of a method of monitoring a computing device in accordance with an embodiment of the present invention. The method is shown generally as 110 and commences at step 112.

At step 114, optionally, generated test signals may be transmitted by a monitoring device (e.g. 20 of FIG. 2) to a controlled computing device (e.g. 30 of FIG. 2) if test signals are required to detect whether a specific error condition is present in the controlled computing device.

At step 116, signals generated by the controlled computing device are received by the monitoring device for consideration.

At step 118, the monitoring device determines whether an error condition is present in the controlled computing device from the signals received at step 116. The monitoring device determines if, for example:

(i) the controlled computing device is operating in a “text mode”;

(ii) data output from the controlled computing device fails to comprise a prespecified string of characters within a prespecified period of time or data output from the controlled computing device comprises a prespecified string of characters where none is expected;

(iii) a signal to illuminate a prespecified light on a keyboard in response to the simulation of the pressing of a prespecified keyboard key is not received from the controlled computing device;

(iv) echo requests are not received in response to a prespecified percentage of ping requests within a prespecified period of time; and/or

(v) a web page is not successfully retrieved in response to a request to retrieve a web page from the controlled computing device.

The nature of these error conditions were described in greater detail with reference to FIG. 2. Other error conditions may be monitored by the monitoring device. Multiple error conditions, possibly as selected by a user, may be monitored by the monitoring device.

At step 120, if the monitoring device has determined that an error condition is present in the controlled computing device at step 118, an error indicator associated with that error condition is generated. This error indicator may be used to output an indication of the error condition to a local user (e.g. using a set of LEDs), a remote user, or to a storage device or a memory.

At step 122, optionally, a message may be generated and output if an error indicator is generated at step 120. The message may be data for a log record to be stored in a storage device (e.g. a memory), or a message to be delivered to a user on a network in the form of an electronic mail message, or a text message to a cell phone, pager, other portable communications device, or any other device connected to the network, for example. The message may be generated in a variety of formats as is known. The message may include, for example, the date and time the error condition was determined to be present in the controlled computing device, data items from data received from controlled computing device at step 116, or other information.

At step 124, optionally, where a relay for controlling the power to the controlled computing device is connected to both the controlled computing device and a power source for the controlled computing device, if it is determined at step 118 that an error condition is present in the controlled computing device, the controlled computing device can be rebooted by moving the relay to the “off” position (possibly for some pre-determined period of time) if it is currently in the “on” position, and then moving the relay back to the “on” position. This causes the controlled computing device to be powered off and then on, effecting a reboot of the controlled computing device.

At step 126, it is determined whether steps in method 110 are to be repeated to continue the monitoring of the controlled computing device. If so, the flow of method steps proceeds back to step 114. Otherwise, the flow of method steps proceeds to step 128. Step 128 marks the end of method 110.

Most preferably, the controlled computing device is monitored for error conditions regularly at some predefined interval. The steps of method 110 may be repeated at the predefined interval. The steps of method 110 may also be repeated for different error conditions, and several instances of the method 110 may be performed simultaneously to monitor the controlled computing device for the different error conditions. The steps of each instance of the method 110 being performed may be repeated at different predefined intervals.

The present invention has been described with regard to preferred embodiments. However, it will be obvious to persons skilled in the art that a number of variants and modifications can be made without departing from the scope of the invention as described herein.

1. An apparatus for remotely monitoring and controlling a computing device, said apparatus comprising one or more stages adapted to:
(a) receive one or more first signals from a controlled computing device coupled to said apparatus;
(b) receive one or more second signals from a user over a network connection;
(c) transmit at least one of said one or more first signals to said user over said network connection; and
(d) transmit said one or more second signals to said controlled computing device;
wherein said apparatus is coupled to a relay, wherein said relay is coupled to both said controlled computing device and a power source for said controlled computing device, wherein said relay is moveable between a first position and a second position, wherein in said first position, said relay causes said power source to be coupled to said controlled computing device, wherein in said second position, said relay causes said power source to be decoupled from said controlled computing device, and wherein at least one of said one or more stages controls the movement of said relay between said first and second positions.

2. The apparatus of claim 1, wherein each of said first signals is selected from the set of: a video signal, and an output data signal.

3. The apparatus of claim 2, wherein each of said second signals is selected from the set of: a signal generated by a keyboard, a signal generated by a mouse, and a signal generated by an input device.

4. The apparatus of claim 3, wherein at least one of said one or more first signals transmitted to said user are transmitted to one of the devices selected from the set of: a video display device, a text display device, and an output peripheral device.

5. The apparatus of claim 1 further comprising a converter for converting at least one of said one or more first signals into digitized form for transmission over said network connection.

6. The apparatus of claim 5, wherein said converter is adapted to convert into digitized form at least one of said one or more first signals from each of a plurality of computing devices coupled to said apparatus.

7. The apparatus of claim 1, wherein said one or more stages are further adapted to receive signals from a plurality of users, and to transmit signals to a plurality of users.

8. The apparatus of claim 1, wherein said apparatus further comprises a multiplexer for coupling to a plurality of computing devices and for permitting said user to select a controlled computing device to be monitored from said plurality of computing devices.

9. The apparatus of claim 1, wherein said apparatus comprises a plurality of multiplexers, each of said plurality of multiplexers for coupling to a plurality of computing devices, wherein said plurality of multiplexers permits each of a plurality of users to select a controlled computing device to be monitored from said plurality of computing devices.

10. The apparatus of claim 1, wherein said one or more stages comprise a video input stage and a control stage, wherein said video input stage is implemented using a first device, and wherein said control stage is implemented using one or more second devices.

11. The apparatus of claim 1, wherein said control stage is implemented using a microprocessor and a gate array.

12. The apparatus of claim 1, wherein said one or more stages are implemented using a single semiconductor device.

13. The apparatus of claim 12, wherein said single semiconductor device is a microprocessor.

14. An apparatus for monitoring a computing device, said apparatus comprising one or more stages adapted to:
(a) receive one or more signals from a controlled computing device;
(b) determining whether an error condition is present in said controlled computing device from said one or more signals; and
(c) generating an error indicator upon determining that an error condition is present in said controlled computing device.

15. The apparatus of claim 14, wherein each of said one or more signals is selected from the set of: a video signal from said controlled computing device, and an output data signal from said controlled computing device.

16. The apparatus of claim 14, wherein said one or more stages are further adapted to output said error indicator.

17. The apparatus of claim 14, wherein said one or more stages comprises a control stage, and wherein said control stage is implemented using a microprocessor and a gate array.

18. The apparatus of claim 14, wherein said one or more stages are implemented using a single semiconductor device.

19. The apparatus of claim 18, wherein said single semiconductor device is a microprocessor.

20. The apparatus as claimed in claim 14, wherein said apparatus comprises software that uses said error indicator to generate a message.

21. The apparatus as claimed in claim 20 further comprising a storage device, wherein said message comprises data for a log record for storing in said storage device.

22. The apparatus as claimed in claim 21, wherein said data comprises a date and a time that indicates when said error condition was determined.

23. The apparatus as claimed in claim 20, wherein said apparatus is coupled to a network, and wherein said message is sent to a user through said network.

24. The apparatus as claimed in claim 23, wherein said message is an electronic mail message comprising details of said error condition.

25. The apparatus as claimed in claim 14, wherein said apparatus coupled to a relay through a relay connection, wherein said relay is coupled to both said controlled computing device and a power source for said controlled computing device, wherein said relay is moveable between a first position and a second position, wherein in said first position, said relay causes said power source to be coupled to said controlled computing device, wherein in said second position, said relay causes said power source to be decoupled from said controlled computing device, wherein said one or more stages are adapted to control the movement of said relay between said first and second positions, and wherein upon determining that an error condition is present in said controlled computing device, the following steps are performed:
(i) said relay is moved to said second position if said relay is in said first position, such that said controlled computing device is powered off; and
(ii) said relay is moved from said second position to said first position after (i) is performed, such that said controlled computing device is powered on.

26. The apparatus as claimed in claim 14, wherein said one or more signals comprise signals associated with a video mode in which said controlled computing device is operating, wherein said signals associated with said video mode are used in determining whether an error condition is present in said controlled computing device.

27. The apparatus as claimed in claim 26, wherein said one or more stages are adapted to determine whether said controlled computing device is operating in a text mode and to generate said error indicator if said controlled computing device is operating in a text mode.

28. The apparatus as claimed in claim 27, wherein said apparatus comprises software that uses said error indicator to generate a message.

29. The apparatus as claimed in claim 28 further comprising a storage device, wherein said message comprises data for a log record for storing in said storage device.

30. The apparatus as claimed in claim 29, wherein said data comprises a date and a time that indicates when said error condition was determined.

31. The apparatus as claimed in claim 28, wherein said apparatus is coupled to a network, and wherein said message is sent to a user through said network.

32. The apparatus as claimed in claim 31, wherein said message is an electronic mail message comprising details of said error condition.

33. The apparatus as claimed in claim 27, wherein said apparatus coupled to a relay through a relay connection, wherein said relay is coupled to both said controlled computing device and a power source for said controlled computing device, wherein said relay is moveable between a first position and a second position, wherein in said first position, said relay causes said power source to be coupled to said controlled computing device, wherein in said second position, said relay causes said power source to be decoupled from said controlled computing device, wherein said one or more stages are adapted to control the movement of said relay between said first and second positions, and wherein upon determining that an error condition is present in said controlled computing device, the following steps are performed:
(i) said relay is moved to said second position if said relay is in said first position, such that said controlled computing device is powered off; and
(ii) said relay is moved from said second position to said first position after (i) is performed, such that said controlled computing device is powered on.

34. The apparatus as claimed in claim 14, wherein said one or more signals comprise an output data signal from said controlled computing device.

35. The apparatus as claimed in claim 34, wherein said output data signal is received by said one or more stages from a serial port on said controlled computing device.

36. The apparatus as claimed in claim 35, wherein said one or more stages are adapted to perform one of the following to determine if an error condition is present in said controlled computing device:
(i) a first string detection method, wherein said one or more stages are adapted to determine whether said output data signal comprises a prespecified string of characters, and wherein said one or more stages are further adapted to generate said error indicator if said output data signal comprises said prespecified string of characters; and
(ii) a second string detection method, wherein said one or more stages are adapted to determine whether said output data signal has not comprised a prespecified string of characters within a prespecified interval, and wherein said one or more stages are further adapted to generate said error indicator if said output data signal has not comprised said prespecified string of characters within said prespecified interval.

37. The apparatus as claimed in claim 36, wherein said apparatus comprises software that uses said error indicator to generate a message.

38. The apparatus as claimed in claim 37 further comprising a storage device, wherein said message comprises data for a log record for storing in said storage device.

39. The apparatus as claimed in claim 38, wherein said data comprises a date and a time that indicates when said error condition was determined.

40. The apparatus as claimed in claim 37, wherein said apparatus is coupled to a network, and wherein said message is sent to a user through said network.

41. The apparatus as claimed in claim 40, wherein said message is an electronic mail message comprising details of said error condition.

42. The apparatus as claimed in claim 36, wherein said apparatus coupled to a relay through a relay connection, wherein said relay is coupled to both said controlled computing device and a power source for said controlled computing device, wherein said relay is moveable between a first position and a second position, wherein in said first position, said relay causes said power source to be coupled to said controlled computing device, wherein in said second position, said relay causes said power source to be decoupled from said controlled computing device, wherein said one or more stages are adapted to control the movement of said relay between said first and second positions, and wherein upon determining that an error condition is present in said controlled computing device, the following steps are performed:
(i) said relay is moved to said second position if said relay is in said first position, such that said controlled computing device is powered off; and
(ii) said relay is moved from said second position to said first position after (i) is performed, such that said controlled computing device is powered on.

43. The apparatus as claimed in claim 14, wherein said one or more stages are adapted to generate one or more test signals, wherein said one or more test signals are transmitted to said controlled computing device and are used to determine if an error condition is present in said controlled computing device, and wherein said one or more first signals comprise signals that are generated by said controlled computing device in response to said one or more test signals.

44. The apparatus as claimed in claim 43, wherein said one or more test signals simulate a press of a prespecified key on a keyboard, wherein said one or more stages are further adapted to: determine whether a signal was not transmitted by said controlled computing device to illuminate a prespecified light on said keyboard in response to said one or more test signals, and generate said error indicator if said signal was not transmitted by said controlled computing device to illuminate said prespecified light on said keyboard in response to said one or more test signals

45. The apparatus as claimed in claim 43, wherein said prespecified key is selected from the set of:
(i) a num lock key;
(ii) a caps lock key;
(iii) a scroll lock key;
and wherein said prespecified light is respectively selected from the set of:
(i) a num lock light;
(ii) a caps lock light;
(iii) a scroll lock light.

46. The apparatus as claimed in claim 44, wherein said apparatus comprises software that uses said error indicator to generate a message.

47. The apparatus as claimed in claim 46 further comprising a storage device, wherein said message comprises data for a log record for storing in said storage device.

48. The apparatus as claimed in claim 47, wherein said data comprises a date and a time that indicates when said error condition was determined.

49. The apparatus as claimed in claim 46, wherein said apparatus is coupled to a network, and wherein said message is sent to a user through said network.

50. The apparatus as claimed in claim 49, wherein said message is an electronic mail message comprising details of said error condition.

51. The apparatus as claimed in claim 44, wherein said apparatus coupled to a relay through a relay connection, wherein said relay is coupled to both said controlled computing device and a power source for said controlled computing device, wherein said relay is moveable between a first position and a second position, wherein in said first position, said relay causes said power source to be coupled to said controlled computing device, wherein in said second position, said relay causes said power source to be decoupled from said controlled computing device, wherein said one or more stages are adapted to control the movement of said relay between said first and second positions, and wherein upon determining that an error condition is present in said controlled computing device, the following steps are performed:
(i) said relay is moved to said second position if said relay is in said first position, such that said controlled computing device is powered off; and
(ii) said relay is moved from said second position to said first position after (i) is performed, such that said controlled computing device is powered on.

52. The apparatus as claimed in claim 43, wherein said controlled computing device is connected to a network selected from the set of: the Internet, and internal network.

53. The apparatus as claimed in claim 43, wherein said one or more test signals comprise one or more ping requests, wherein said one or more stages are adapted to determine whether an echo response has not been received from said controlled computing device in response to a prespecified percentage of said one or more ping requests within a prespecified period of time, and wherein said one or more stages are further adapted to generate said error indicator if an echo response has not been received from said controlled computing device in response to a prespecified percentage of said one or more ping requests within said prespecified period of time.

54. The apparatus as claimed in claim 53, wherein said apparatus comprises software that uses said error indicator to generate a message.

55. The apparatus as claimed in claim 54 further comprising a storage device, wherein said message comprises data for a log record for storing in said storage device.

56. The apparatus as claimed in claim 55, wherein said data comprises a date and a time that indicates when said error condition was determined.

57. The apparatus as claimed in claim 54, wherein said apparatus is coupled to a network, and wherein said message is sent to a user through said network.

58. The apparatus as claimed in claim 57, wherein said message is an electronic mail message comprising details of said error condition.

59. The apparatus as claimed in claim 53, wherein said apparatus coupled to a relay through a relay connection, wherein said relay is coupled to both said controlled computing device and a power source for said controlled computing device, wherein said relay is moveable between a first position and a second position, wherein in said first position, said relay causes said power source to be coupled to said controlled computing device, wherein in said second position, said relay causes said power source to be decoupled from said controlled computing device, wherein said one or more stages are adapted to control the movement of said relay between said first and second positions, and wherein upon determining that an error condition is present in said controlled computing device, the following steps are performed:
(i) said relay is moved to said second position if said relay is in said first position, such that said controlled computing device is powered off; and
(ii) said relay is moved from said second position to said first position after (i) is performed, such that said controlled computing device is powered on.

60. The apparatus as claimed in claim 43, wherein said controlled computing device is a web server, wherein said one or more test signals comprise a request to retrieve a web page, wherein said one or more stages are adapted to determine whether a web page was not successfully retrieved from said controlled computing device in response to said request to retrieve said web page, and wherein said one or more stages are further adapted to generate said error indicator if said web page was not successfully retrieved from said controlled computing device in response to said request to retrieve said web page.

61. The apparatus as claimed in claim 60, wherein said apparatus comprises software that uses said error indicator to generate a message.

62. The apparatus as claimed in claim 61 further comprising a storage device, wherein said message comprises data for a log record for storing in said storage device.

63. The apparatus as claimed in claim 62, wherein said data comprises a date and a time that indicates when said error condition was determined.

64. The apparatus as claimed in claim 61, wherein said apparatus is coupled to a network, and wherein said message is sent to a user through said network.

65. The apparatus as claimed in claim 64, wherein said message is an electronic mail message comprising details of said error condition.

66. The apparatus as claimed in claim 60, wherein said apparatus coupled to a relay through a relay connection, wherein said relay is coupled to both said controlled computing device and a power source for said controlled computing device, wherein said relay is moveable between a first position and a second position, wherein in said first position, said relay causes said power source to be coupled to said controlled computing device, wherein in said second position, said relay causes said power source to be decoupled from said controlled computing device, wherein said one or more stages are adapted to control the movement of said relay between said first and second positions, and wherein upon determining that an error condition is present in said controlled computing device, the following steps are performed:
(i) said relay is moved to said second position if said relay is in said first position, such that said controlled computing device is powered off; and
(ii) said relay is moved from said second position to said first position after (i) is performed, such that said controlled computing device is powered on.

67. The apparatus as claimed in claim 14, wherein said one or more stages are further adapted to determine whether one or more selected error conditions of a plurality of error conditions are present in said controlled computing device from said one or more second signals, and to generate one or more error indicators to indicate which error conditions of said plurality of error conditions are present in said controlled computing device.

68. The apparatus as claimed in claim 67, wherein said apparatus further comprises software that allows a user to define said plurality of error conditions.

69. A method of monitoring a computing device, the method comprising the steps of:
(a) receiving a plurality of signals generated by a controlled computing device;
(b) determining from said plurality of signals whether an error condition is present in said controlled computing device; and
(c) generating an error indicator upon determining that an error condition is present in said controlled computing device.

70. The method of claim 69, wherein each of said plurality of signals comprises one of the following: a video signal from said controlled computing device, and an output data signal from said controlled computing device.

71. The method as claimed in claim 69, wherein said error indicator is used to generate a message.

72. The method as claimed in claim 71, wherein said message comprises data for a log record for storing in a storage device.

73. The method as claimed in claim 72, wherein said data comprises a date and a time, wherein said date and time indicates when said error condition was determined at step (b).

74. The method as claimed in claim 71, wherein said message is sent to a user through a network.

75. The method as claimed in claim 74, wherein said message is an electronic mail message.

76. The method as claimed in claim 69, wherein a relay is coupled to both said controlled computing device and a power source for said controlled computing device, and wherein upon determining that an error condition is present in said controlled computing device, the following steps are performed:
(i) said relay is moved to a second position if said relay is in said first position, such that said controlled computing device is powered off; and
(ii) after step (i) is performed, said relay is moved from said second position to said first position, such that said controlled computing device is powered on.

77. The method as claimed in claim 69, wherein said plurality of signals comprise signals associated with a video mode in which said controlled computing device is operating, wherein said signals associated with said video mode are used in determining whether an error condition is present in said controlled computing device.

78. The method as claimed in claim 77, wherein step (b) comprises determining whether said controlled computing device is operating in a text mode, and wherein step (c) comprises generating said error indicator if said controlled computing device is operating in a text mode as determined at step (b).

79. The method as claimed in claim 78, wherein said error indicator is used to generate a message.

80. The method as claimed in claim 79, wherein said message comprises data for a log record for storing in a storage device.

81. The method as claimed in claim 80, wherein said data comprises a date and a time, wherein said date and time indicates when said error condition was determined at step (b).

82. The method as claimed in claim 79, wherein said message is sent to a user through a network.

83. The method as claimed in claim 72, wherein said message is an electronic mail message.

84. The method as claimed in claim 78, wherein a relay is coupled to both said controlled computing device and a power source for said controlled computing device, and wherein upon determining that an error condition is present in said controlled computing device, the following steps are performed:
(i) said relay is moved to a second position if said relay is in said first position, such that said controlled computing device is powered off; and
(iii) after step (i) is performed, said relay is moved from said second position to said first position, such that said controlled computing device is powered on.

85. The method as claimed in claim 69, wherein said plurality of signals comprise an output data signal from said controlled computing device.

86. The method as claimed in claim 85, wherein said output data signal is provided by a serial port on said controlled computing device.

87. The method as claimed in claim 86, wherein one of the following is performed to determine if an error condition is present in said controlled computing device:
(i) a first string detection method, wherein step (b) comprises determining whether said output data signal comprises a prespecified string of characters, and wherein step (c) comprises generating said error indicator if said output data signal comprises said prespecified string of characters as determined at step (b); and
(ii) a second string detection method wherein step (b) comprises determining whether said output data signal has not comprised a prespecified string of characters within a prespecified interval, and wherein step (c) comprises generating said error indicator if said output data signal has not comprised said prespecified string of characters within said prespecified interval as determined at step (b).

88. The method as claimed in claim 87, wherein said error indicator is used to generate a message.

89. The method as claimed in claim 88, wherein said message comprises data for a log record for storing in a storage device.

90. The method as claimed in claim 89, wherein said data comprises a date and a time, wherein said date and time indicates when said error condition was determined at step (b).

91. The method as claimed in claim 88, wherein said message is sent to a user through a network.

92. The method as claimed in claim 91, wherein said message is an electronic mail message.

93. The method as claimed in claim 87, wherein a relay is coupled to both said controlled computing device and a power source for said controlled computing device, and wherein upon determining that an error condition is present in said controlled computing device, the following steps are performed:
(i) said relay is moved to a second position if said relay is in said first position, such that said controlled computing device is powered off; and
(ii) after step (i) is performed, said relay is moved from said second position to said first position, such that said controlled computing device is powered on.

94. The method as claimed in claim 69, wherein said method also comprises the steps of generating one or more test signals, and transmitting said one or more test signals to said controlled computing device to determine if an error condition is present in said controlled computing device, wherein said plurality of signals received at step (a) comprise signals that are generated by said controlled computing device in response to said one or more test signals.

95. The method as claimed in claim 94, wherein said one or more test signals simulate a press of a prespecified key on a keyboard, wherein step (b) comprises determining whether a signal to illuminate a prespecified light on said keyboard in response to said one or more test signals has not been received from said controlled computing device, and wherein step (c) comprises generating said error indicator if said signal to illuminate a prespecified light on said keyboard in response to said one or more test signals has not been received from said controlled computing device as determined at step (b).

96. The method as claimed in claim 95, wherein said prespecified key is selected from the set of:
(i) num lock key;
(ii) caps lock key;
(iii) scroll lock key;
and wherein said prespecified light is respectively one of the following:
(i) num lock light;
(ii) caps lock light;
(iii) scroll lock light.

97. The method as claimed in claim 95, wherein said error indicator is used to generate a message.

98. The method as claimed in claim 97, wherein said message comprises data for a log record for storing in a storage device.

99. The method as claimed in claim 98, wherein said data comprises a date and a time, wherein said date and time indicates when said error condition was determined at step (b).

100. The method as claimed in claim 97, wherein said message is sent to a user through a network.

101. The method as claimed in claim 100, wherein said message is an electronic mail message.

102. The method as claimed in claim 95, wherein a relay is coupled to both said controlled computing device and a power source for said controlled computing device, and wherein upon determining that an error condition is present in said controlled computing device, the following steps are performed:
(i) said relay is moved to a second position if said relay is in said first position, such that said controlled computing device is powered off; and
(ii) after step (i) is performed, said relay is moved from said second position to said first position, such that said controlled computing device is powered on.

103. The method as claimed in claim 94, wherein said one or more test signals comprise one or more ping requests, wherein step (b) comprises determining whether an echo response has not been received from said controlled computing device in response to a prespecified percentage of said one or more ping requests within a prespecified period of time, and wherein step (c) comprises generating said error indicator if said echo response has not been received from said controlled computing device in response to said prespecified percentage of said one or more ping requests within a prespecified period of time as determined at step (b).

104. The method as claimed in claim 103, wherein said error indicator is used to generate a message.

105. The method as claimed in claim 104, wherein said message comprises data for a log record for storing in a storage device.

106. The method as claimed in claim 105, wherein said data comprises a date and a time, wherein said date and time indicates when said error condition was determined at step (b).

107. The method as claimed in claim 104, wherein said message is sent to a user through a network.

108. The method as claimed in claim 107, wherein said message is an electronic mail message.

109. The method as claimed in claim 103, wherein a relay is coupled to both said controlled computing device and a power source for said controlled computing device, and wherein upon determining that an error condition is present in said controlled computing device, the following steps are performed:
(i) said relay is moved to a second position if said relay is in said first position, such that said controlled computing device is powered off; and
(ii) after step (i) is performed, said relay is moved from said second position to said first position, such that said controlled computing device is powered on.

110. The method as claimed in claim 94, wherein said controlled computing device is a web server, wherein said one or more test signals comprise a request to retrieve a web page, wherein step (b) comprises determining whether a web page was not successfully retrieved from said controlled computing device in response to said request to retrieve said web page, and wherein step (c) comprises generating said error indicator if said web page was not successfully retrieved from said controlled computing device in response to said request to retrieve said web page as determined at step (b).

111. The method as claimed in claim 110, wherein said error indicator is used to generate a message.

112. The method as claimed in claim 111, wherein said message comprises data for a log record for storing in a storage device.

113. The method as claimed in claim 112, wherein said data comprises a date and a time, wherein said date and time indicates when said error condition was determined at step (b).

114. The method as claimed in claim 111, wherein said message is sent to a user through a network.

115. The method as claimed in claim 115, wherein said message is an electronic mail message.

116. The method as claimed in claim 110, wherein a relay is coupled to both said controlled computing device and a power source for said controlled computing device, and wherein upon determining that an error condition is present in said controlled computing device, the following steps are performed:
(i) said relay is moved to a second position if said relay is in said first position, such that said controlled computing device is powered off; and
(ii) after step (i) is performed, said relay is moved from said second position to said first position, such that said controlled computing device is powered on.

117. The method as claimed in claim 69, wherein the steps of said method are repeated for one or more selected error conditions of a plurality of error conditions.

118. The method as claimed in claim 117, wherein said method further comprises the step of receiving input from a user, wherein said input is used to define said plurality of error conditions.

119. The method as claimed in claim 69 further comprising the step of outputting said error indicator.
